(19) United States
(12) Patent Application Publication
(10) Pub. No.: US 2021/0388549 A1
(43) Pub. Date: Dec. 16, 2021

(54) FIBER STRUCTURE

(71) Applicant: ENEOS CORPORATION, Tokyo (JP)

(72) Inventors: Kousuke YAMAKI, Tokyo (JP); Kunio GOTO, Tokyo (JP)

(73) Assignee: ENEOS CORPORATION, Tokyo (JP)

(21) Appl. No.: 17/287,499

(22) PCT Filed: Jul. 4, 2019
(86) PCT No.: PCT/JP2019/026602

§ 371 Date: Apr. 21, 2021

(30) Foreign Application Priority Data
Oct. 30, 2018 (JP) JP 2018-204196

(51) Int. Cl. D04H 1/74; C08K 3/22

(52) U.S. Cl. CPC D04H 1/74; C08K 3/22; B82Y 40/00; C08K 2201/011; C08K 2003/2258

(57) ABSTRACT

A sheet-like fiber structure (101) includes a plurality of first resin fibers with a plurality of gap portions, in which the plurality of first resin fibers each contain fine particles of tungsten-based oxide in a dispersed form. The content of the fine particles of tungsten-based oxide is preferably 0.5 wt % or more and 6 wt % or less relative to a total weight of the plurality of first resin fibers. By dispersing, into each of the plurality of first resin fibers that constitute the fiber structure (101), the fine particles of tungsten-based oxide having an optical wavelength-selective reflectivity of transmitting visible light and reflecting infrared light, it is possible to achieve both of high transmittance of visible light and high heat shielding performance.

### TECHNICAL FIELD

The present invention relates to a sheet-like fiber structure including a plurality of resin fibers, and more particularly, to a fiber structure having light transmitting and heat shielding properties.

### BACKGROUND ART

Conventionally, nonwoven fabrics are known, which are prepared as an example of the fiber structure by adding a heat shielding tiller to a resin serving as a base of the nonwoven fabric, to thereby have a high heat shielding property while allowing light transmission (for example, see Patent Document 1). To give examples of the filler, a titanium oxide powder, an aluminum powder, and a black mica powder have been used conventionally. Such nonwoven fabrics having the light transmitting and heat shielding properties are suitable as a covering material for an agricultural greenhouse or other applications, and are available on the market.

### REFERENCE DOCUMENT LIST

### Patent Document

Patent Document 1: JP 2006-187256 A

### SUMMARY OF THE INVENTION

### Problem to be Solved by the Invention

In the above conventional nonwoven fabrics, however, the filler to be added for heat shielding has little wavelength selectivity for light transmission. This causes a problem that, if attempting to reduce the transmittance of infrared light to enhance a heat shielding effect, the transmittance of visible light also drops. Patent Document 1 above is directed to setting, in an appropriate range, particle sizes, particle size distributions, and amounts of fillers to be added, so as to achieve the wavelength selectivity for light transmission. However, the titanium oxide or other material itself, which has been so far employed in nonwoven fabrics, has little wavelength selectivity as described above. Thus, even though the particle sizes, particle size distributions, and added amounts are optimized, there is a limit to improvement in the optimization.

Specifically, if we consider the case in which the structure is used as, for example, a covering material for an agricultural greenhouse as discussed above, visible light is necessary for plant photosynthesis. Hence, if a heat shielding effect is enhanced and in exchange, the transmittance of visible light drops, the heat shielding effect and the light transmission may become out of balance, resulting in an adverse effect on the growth of crops. Another problem is that, if the transmittance of visible light drops, the inside of the greenhouse gets too dark to work in without great difficulty. Also, if we consider the case of using the above conventional nonwoven fabric as, for example, a curtain, a window blind, or a paper screen, an attempt to enhance an effect of suppressing temperature increase caused by external light leads to a problem that the interior space may become too dark.

The present invention has been made in view of the above, and it is accordingly an object of the present invention to provide a fiber structure capable of achieving high heat shielding performance while suppressing reduction in transmittance of visible light.

### Means for Solving the Problem

In order to achieve the above object, the present invention provides a sheet-like fiber structure comprising a plurality of first resin fibers, wherein the fiber structure has a plurality of gap portions, and the plurality of first resin fibers each contain fine particles of tungsten-based oxide in a dispersed form.

### Effects of the Invention

According to the present invention, the plurality of first resin fibers each contain, in the dispersed form, the fine particles of tungsten-based oxide that have optical wavelength-selective reflectivity of transmitting the visible light and reflecting the infrared light, by which the fiber structure having both of high transmittance of visible light and high heat shielding performance can be provided.

### BRIEF DESCRIPTION OF THE DRAWINGS

FIG. 1 is a perspective view of a fiber structure according to Embodiment 1 of the present invention.

FIG. 2 is a perspective view of a fiber structure according to Embodiment 2 of the present invention.

FIG. 3 is a plan view of a fiber structure according to Embodiment 3 of the present invention.

FIG. 4 shows the structure of a multilayer film suitable for interlayer adhesion.

FIG. 5 is a plan view of a fiber structure according to Embodiment 4 of the present invention.

FIG. 6 is a plan view of a fiber structure according to Embodiment 5 of the present invention.

FIG. 7 is a perspective view of a fiber structure according to Embodiment 6 of the present invention.

FIG. 8 is an enlarged view of the schematic structure of a fiber structure according to Embodiment 7 of the present invention.

FIG. 9 is an enlarged view of the schematic structure of a fiber structure according to Embodiment 8 of the present invention.

FIG. 10 is a table showing characteristics of Examples 1 and 2 of the present invention and Comparative Example 1.

FIG. 11 shows a relationship between transmittance of visible light and the content, and a relationship between a heat shield temperature and the content, for each measurement result of Examples 1 and 2 and Comparative Example 1.

FIG. 12 shows results of evaluating advantages of Examples 1 and 2 over Comparative Example 1.

FIG. 13 shows a relationship of the heat shield temperature to the transmittance of visible light, for each measurement result of evaluation samples with aperture ratios of 34% and 50%.

### MODE FOR CARRYING OUT THE INVENTION

A fiber structure according to the present invention is a sheet-like fiber structure including a plurality of first resin fibers with a plurality of gap portions. The plurality of first resin fibers each contain fine particles of tungsten-based oxide in a dispersed form. The plurality of gap portions are spaces or voids that may exist between the first resin fibers, and these gap portions correspond to openings of nonwoven or woven fabrics, for example.

The fine particles of tungsten-based oxide in the plurality of first resin fibers are fine particles of tungsten oxide or composite tungsten oxide. The tungsten oxide is represented by the general formula. WxOy, where W is tungsten, O is oxygen, and x and y are constants. The composite tungsten oxide is represented by the general formula, MzWxOy, where M is an element different from tungsten, for example, alkali metal represented by cesium (Cs), and z is a constant.

The above fine particles of tungsten-based oxide have an optical wavelength-selective reflectivity of transmitting the visible light and reflecting the infrared light. Films or sheets that are prepared by dispersing fine particles of tungsten-based oxide to achieve heat shielding performance, are already known (for example, see JP 2018-43397 A and JP 2011-93280 A). The present invention focuses on the optical wavelength-selective reflectivity of the above fine particles of tungsten-based oxide, and discloses a specific structure that realizes an application in which fine particles of tungsten-based oxide are directly dispersed as a heat shielding filler into nonwoven fabrics or other fiber structures, in place of the titanium oxide powder or other material of the above-mentioned conventional nonwoven fabrics.

In the fiber structure of the present invention, the content of the fine particles of tungsten-based oxide is preferably 0.5 wt % or more and 6 wt % or less relative to the total weight of the plurality of first resin fibers. If the content of the fine particles of tungsten-based oxide is too high, the fine particles may aggregate in the first resin fiber, resulting in non-uniform dispersion (uneven concentration distribution). In contrast, if the content of the fine particles of tungsten-based oxide is too low, the effect of the heat shielding filler itself may not be easily available. To address the above, the content of the fine particles of tungsten-based oxide is set in the above range, as will be described in detail in Examples below.

In the fiber structure of the present invention, the plurality of first resin fibers are preferably stretched in a first direction. The fiber structure of the present invention may further include a plurality of second resin fibers stretched in a direction orthogonal to the first direction. By stretching the resin fibers in one direction, constituent molecules of the resin fiber are oriented in the stretching direction. With this orientation, the fiber structure has relatively high strength in the stretching direction. The first resin fibers and the second resin fibers have orthogonal stretching directions. Consequently, the fiber structure prepared by laminating or weaving them can produce a nonwoven fabric or woven fabric having high strength. Here, the stretching direction (first direction) of the first resin fiber and the stretching direction (second direction) of the second resin fiber may not be exactly orthogonal and can be substantially orthogonal.

The plurality of second resin fibers can each contain fine particles of tungsten-based oxide in a dispersed form. In this case, the content of the fine particles of tungsten-based oxide is preferably 0.5 wt % or more and 6 wt % or less relative to the total weight of the plurality of second resin fibers as in the plurality of first resin fibers.

Moreover, the fine particles of tungsten-based oxide in the plurality of first resin fibers (and the plurality of second resin fibers) preferably have an average particle size of 100 nm or less. The “average particle size” used herein refers to the “arithmetic average diameter of particles imaged by optical microscopy or transmission electron microscopy” as defined in JIS Z 8901. As is generally known, fine particles of tungsten-based oxide having the particle sizes of 200 nm or less cause Rayleigh scattering. In this regard, fine particles of smaller particle sizes cause less scattering of visible light. Moreover, fine particles having particle sizes of 100 nm or less rarely cause the scattering of visible light. Considering the above influence of fine particle aggregation in the resin fiber as well, the fiber structure of the present invention selectively adopts fine particles having the average particle size of 100 nm or less, preferably 10 nm or less, to achieve high transmittance of visible light.

In the fiber structure of the present invention, the transmittance of visible light is preferably 70% or more. In addition, a maximum temperature reached in a given closed space (hereinafter referred to as “maximum reachable temperature”) decreases preferably by 7° C. or more when light containing infrared light is applied to the closed space through the fiber structure as compared with when the light containing infrared light is directly applied to the closed space. It should be noted that such conditions can be selectively set according to, for example, intended uses of the fiber structure, as will be described in detail in Examples below.

For the transmittance of visible light, a measured value of a total light transmittance conforming to JIS K 7361-1:1997 (ISO 13468-1:1996) is used herein. The total light transmittance can be measured by a known haze meter, for example.

The decrease of the maximum reachable temperature can be measured in the way detailed below, for example. In this example, a styrofoam box (width (W): 320 mm, depth (D): 250 mm, and height (H): 160 mm), an incandescent lamp (RG-200W available from HATAYA Limited), and a temperature sensor are prepared in advance. Then, the inner space of the styrofoam box forms a given closed space. The styrofoam box is left sill in a stable environment. The incandescent lamp is placed above the styrofoam box and also, the temperature sensor is placed inside the styrofoam box. Under these conditions, the incandescent lamp directly applies light containing infrared light to an upper portion of the styrofoam box. Then, the temperature sensor monitors how the inner temperature of the styrofoam box increases, and measures maximum reachable temperature T₀ thereof. Moreover, the fiber structure is laid on the upper portion of the styrofoam box, and the incandescent lamp applies the light containing infrared light to the upper portion of the styrofoam box through the fiber structure. Then, maximum reachable temperature T₁ is measured in the above way. By subtracting maximum reachable temperature T₁ obtained through the fiber structure from maximum reachable temperature T₀ obtained not through the fiber structure, the above decrease (=T₀−T₁ (° C.)) can be calculated. The decrease of the maximum reachable temperature (hereinafter referred to as “heat shield temperature”) that varies depending on the presence or absence of the fiber structure represents the heat shielding performance of the fiber structure, and a higher heat shield temperature indicates a higher heat shielding performance. Here, the way to measure the maximum reachable temperatures T₀ and T₁ is not limited to the above example.

According to the above fiber structure of the present invention, the plurality of first resin fibers (and the plurality of second resin fibers) each contain fine particles of tungsten-based oxide having the optical wavelength-selective reflectivity of transmitting the visible light and reflecting the infrared light. This structure produces a satisfactory heat shielding effect as well as ensures high transmittance of visible light. Such a fiber structure is suitable as, for example, a covering material for an agricultural greenhouse. When used as the covering material, the fiber structure can fully transmit the visible light, of sunlight, necessary for plant photosynthesis and can selectively reflect the infrared light, to avoid an excessive temperature increase in the greenhouse. Accordingly, improvements in quality and yield of crops can be expected and also, the greenhouse is bright and easy to work in. Moreover, the plurality of gap portions ensure air permeability, which effectively suppresses the temperature increase in the greenhouse together with the heat shielding effect of the fine particles of tungsten-based oxide.

The fiber structure of the present invention is also suitable as, for example, a curtain, a window blind, or a paper screen in addition to the above use as the covering material for an agricultural greenhouse. When used in such an application, the present invention can effectively suppress the temperature increase caused by external light while maintaining the brightness of the interior space, i.e., can provide comfortable interior space. Here, the use of the fiber structure of the present invention is not limited to the above example.

Hereinafter, several embodiments of the fiber structure of the present invention will be described in detail referring to the accompanying drawings.

### Embodiment 1

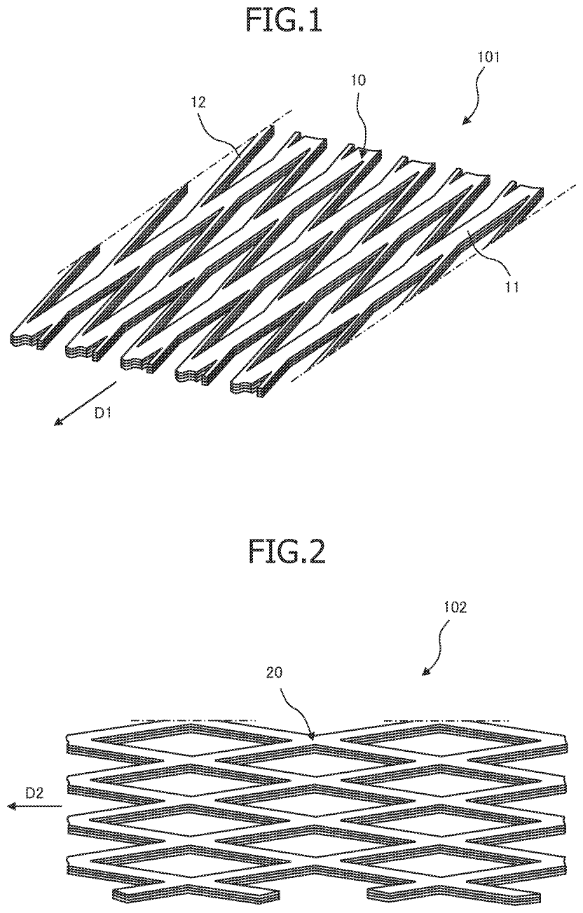

FIG. 1 shows a fiber structure according to Embodiment 1 of the present invention. As shown in FIG. 1, a fiber structure 101 of Embodiment 1 includes a split web 10. The split web 10 is formed of a mesh film that is stretched in one direction D1. The split web 10 can be prepared by stretching in one direction D1 a film that contains fine particles of tungsten-based oxide in a dispersed form, fiber-splitting the film (for example, into a staggered pattern) at a plurality of positions along stretching direction D1, and then extending (widening) the film in a direction substantially orthogonal to stretching direction D1. The split web 10 having such a mesh structure includes a plurality of resin fibers constituting the split web, which include a plurality of base fibers 11 and a plurality of branch fibers 12. The base fibers extend in stretching direction D1, substantially in parallel to each other. Each branch fiber 12 connects adjacent two of the base fibers 11. With the film being stretched in one direction D1, constituent molecules of the film are oriented in stretching direction D1. Consequently, the split web 10 has relatively high strength in the stretching direction (orientation direction of the constituent molecules). In this embodiment, the plurality of resin fibers (basically, base fibers 11) constituting the split web 10 correspond to a plurality of first resin fibers the present invention. Moreover, a plurality of spaces or voids (in a mesh) surrounded by the base fibers 11 and the branch fibers 12 correspond to a plurality of gap portions of the present invention.

The film is made of a thermoplastic resin such as a polyolefin-based resin, and added with a given amount of fine particles of tungsten-based oxide (heat shielding filler) as described above. The fine particles exist in a dispersed form inside the film. The polyolefin-based resin refers to a resin mainly containing polyethylene, polypropylene, or other polyolefin, or a copolymer thereof, and it may contain other resins or additives in an amount that will not impair its characteristics. Conceivable examples of the additives include, aside from the fine particles of tungsten-based oxide which are an essential constituent as the heat shielding filler, dispersants that prevent aggregation of the heat shielding filler, antioxidants, weathering stabilizers, lubricants, anti-blocking agents, antistatic agents, antifog additives, and anti-dripping agents.

An example of a manufacturing method for the above split web 10 is described briefly. First, in a film formation step adopting inflation molding or T-die molding, for example, a polyolefin-based resin added with fine particles of tungsten-based oxide is used as a raw material to form the film. In a subsequent orientation step, the thus-formed film is stretched in one direction into a uniaxially oriented member. In a subsequent splitting step, the film thus stretched into the uniaxially oriented member is subjected to splitting (fiber-splitting). After that, the fiber-split film is widened, if necessary, and then subjected to heat treatment or the like. Through these steps, the split web 10 is manufactured. The split web 10 preferably has the thickness in a range of 20 to 300 μm. If the thickness is too small, the split web 10 cannot have sufficient strength, whereas if the thickness is too large, the split web 10 becomes less flexible. In view of the above, the thickness of the split web 10 is set in the above range.

### Embodiment 2

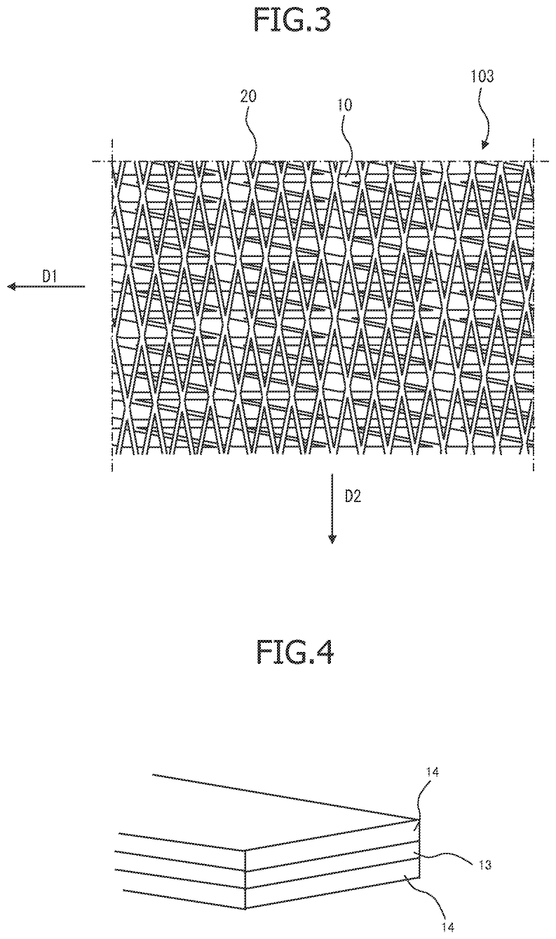

FIG. 2 shows a fiber structure according to Embodiment 2 of the present invention. As shown in FIG. 2, a fiber structure 102 of Embodiment 2 includes a slit web 20. The slit web 20 is formed of a mesh film that is stretched in one direction D2. The slit web 20 can be prepared by slitting a film containing fine particles of tungsten-based oxide in a dispersed form to form a plurality of slits (for example, into a staggered pattern) that extend in direction D2, and then stretching the film in direction D2. With the film being stretched in one direction D2, constituent molecules of the film are oriented in stretching direction D2. Consequently, the slit web 20 having such a diamond-like mesh structure has relatively high strength in the stretching direction (orientation direction of the constituent molecules). In this embodiment, the plurality of resin fibers constituting the slit web 20 correspond to the plurality of first resin fibers of the present invention. Moreover, a plurality of spaces or voids (in a mesh) surrounded by the resin fibers correspond to the plurality of gap portions of the present invention.

Similar to the above film used in the split web 10, the film used in the slit web 20 is made of, for example, a thermoplastic resin such as a polyolefin-based resin, and added with a given amount of fine particles of tungsten-based oxide (heat shielding filler) as described above. The fine particles exist in a dispersed form inside the film.

An example of a manufacturing method for the above slit web 20 is described briefly. First, the film is formed in the same film formation step as the above split web 10. In a subsequent slitting step, the thus-formed film is subjected to slitting. After that, in an orientation step, the film is stretched in one direction into a uniaxially oriented member. The film thus stretched into the uniaxially oriented member is widened, if necessary, and then subjected to heat treatment or the like. Through these steps, the slit web 20 is manufactured. Similar to the above split web 10, the slit web 20 preferably has the thickness in a range of 20 to 300 μm.

### Embodiment 3

FIG. 3 shows a fiber structure according to Embodiment 3 of the present invention. In FIG. 3, a fiber structure 103 of Embodiment 3 is a nonwoven fabric prepared by laminating the split web 10 (FIG. 1) as described in Embodiment 1 and the slit web 20 (FIG. 2) as described in Embodiment 2 with stretching directions D1 and D2 being substantially orthogonal to each other, and then bonding them by thermal compression, for example. The fiber structure 103 (nonwoven fabric) including the cross-laminated split web 10 and slit web 20 also has the mesh structure. In this embodiment, the plurality of resin fibers (basically, base fibers 11) constituting the split web 10 correspond to the plurality of first resin fibers of the present invention, and the plurality of resin fibers constituting the slit web 20 correspond to the plurality of second resin fibers of the present invention.

In the above configuration, as shown in FIG. 4, the film used in the split web 10 and the film used in the slit web 20 are preferably a multilayer film with three-layer structure: a first thermoplastic resin layer 13 and second thermoplastic resin layers 14, for example. The first thermoplastic resin layer 13 is made of a polyolefin-based resin as its base material, and contains fine particles of tungsten-based oxide. The second thermoplastic resin layer 14 is made of linear low density polyethylene (LLDPE) with a melting point lower than the polyolefin-based resin. The second thermoplastic resin layers 14 on both surfaces of the first thermoplastic resin layer 13 serve as bonding layers to bond the laminated layers by thermal compression, for example. This aims at relatively easy and stable thermal compression for integrating (bonding) the split web 10 and the slit web 20. The first thermoplastic resin layer 13 is added with a given amount of fine particles of tungsten-based oxide (heat shielding filler) as described above, and the fine particles exist in a dispersed form inside the layer. Upon laminating and bonding the split web 10 and the slit web 20, the second thermoplastic resin layer 14 on the split web 10 side and the second thermoplastic resin layer 14 on the slit web 20 side function as the bonding layers.

Various characteristics of the fiber structure 103 such as the basis weight, constituent fiber size (thickness and width), and tensile strength thereof, can be controlled by appropriately adjusting the thickness of the first thermoplastic resin layer 13 in the multilayer film, a stretching ratio, a fiber-splitting position of the split web 10, and a slitting position of the slit web 20, for example. In this example, it is preferred to perform the adjustment so that an aperture ratio of the mesh structure, mainly determined by the basis weight and the constituent fiber size, is 68% or less, preferably 50% or less. If the aperture ratio is too high and the gap portions between the resin fibers increase, the transmittance of visible light and the air permeability increase, but the heat shielding effect expected from the added fine particles of tungsten-based oxide lowers. As a result, a desired heat shielding performance may not be easily available. A relationship between the aperture ratio and the heat shielding performance will be described in detail in Examples below.

According to the fiber structure 103 having the above configuration, the split web 10 and the slit web 20 are laminated and bonded with stretching directions D1 and D2 being substantially orthogonal to each other. This structure can produce a nonwoven fabric having a mesh structure with higher strength and stable shape having little expansion and contraction. The above fiber structure 103 is especially suitable as a covering material for an agricultural greenhouse.

### Embodiment 4

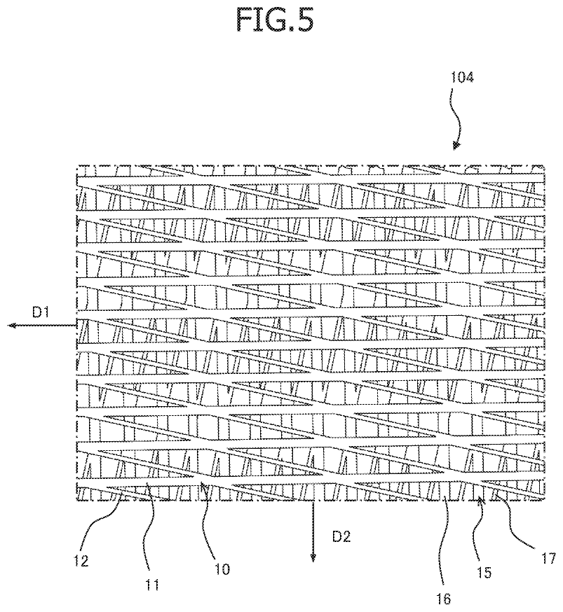

FIG. 5 shows a fiber structure according to Embodiment 4 of the present invention. In FIG. 5, a fiber structure 104 of Embodiment 4 is prepared by laminating two split webs 10 and 15 as described in Embodiment 1 with stretching directions D1 and D2 being substantially orthogonal to each other, and then bonding them by thermal compression, for example. The fiber structure 104 (nonwoven fabric) including the cross-laminated split webs 10 and 15 also has the mesh structure. In this embodiment, the plurality of resin fibers (basically, base fiber 11) constituting one split web, or the split web 10, correspond to the plurality of first resin fibers of the present invention, and the plurality of resin fibers (basically, base fiber 16) constituting the other split web, or the split web 15, correspond to the plurality of second resin fibers of the present invention.

In the above configuration as well, the films used in the split webs 10 and 15 are preferably a multilayer film having the three-layer structure as shown in FIG. 4. Upon laminating and bonding the split webs 10 and 15, the second thermoplastic resin layer 14 on the split web 10 side and the second thermoplastic resin layer 14 on the split web 15 side function as the bonding layers.

Various characteristics of the fiber structure 104 such as the basis weight, constituent fiber size (thickness and width), and tensile strength thereof, can be controlled by appropriately adjusting the thickness of the first thermoplastic resin layer 13 in the film, a stretching ratio, and a fiber-splitting position of the split webs 10 and 15, for example. Also in this case, it is preferred to perform the adjustment so that the aperture ratio is 68% or less, preferably 50% or less as in Embodiment 3. In the fiber structure 104 as well, the two split webs 10 and 15 are laminated and bonded with stretching directions D1 and D2 being substantially orthogonal to each other. This structure can produce a nonwoven fabric having a mesh structure with higher strength and stable shape having little expansion and contraction. Embodiment 4 discusses the configuration example in which the two split webs 10 and 15 are laminated and bonded. However, the present invention can, of course, adopt the configuration in which two slit webs are laminated and bonded in the same manner.

### Embodiment 5

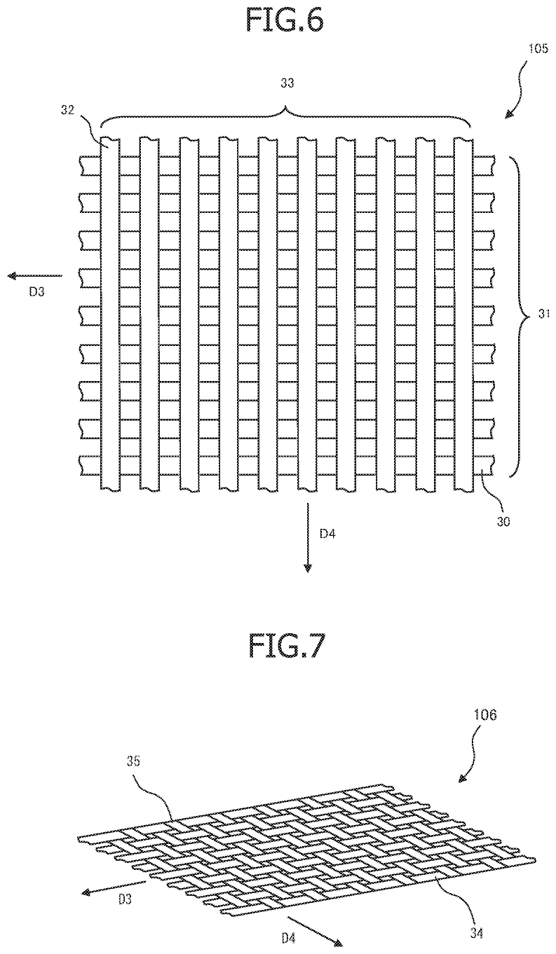

FIG. 6 shows a fiber structure according to Embodiment 5 of the present invention, In FIG. 6, a fiber structure 105 of Embodiment 5 is prepared by warp-and-weft laminating uniaxially stretched multilayer tapes 30 and 32. Specifically, the fiber structure 105 is formed by laminating a uniaxially stretched multilayer tape group 31 (first layer) and a uniaxially stretched multilayer tape group 33 (second layer), and then bonding them by thermal compression, for example. In this case, the uniaxially stretched multilayer tape group 31 includes the plurality of uniaxially stretched multilayer tapes 30 which are stretched in an axial direction (longitudinal direction) and arrayed along direction D3. The uniaxially stretched multilayer tape group 33 includes the plurality of uniaxially stretched multilayer tapes 32 that are stretched in the axial direction (longitudinal direction) and arrayed in direction D4 substantially orthogonal to direction D3. The fiber structure 105 (nonwoven fabric) including the cross-laminated uniaxially stretched multilayer tape groups 31 and 33 also has the mesh structure. In this embodiment, the plurality of uniaxially stretched multilayer tapes 30 constituting the uniaxially stretched multilayer tape group 31 correspond to the plurality of first resin fibers of the present invention, and the plurality of uniaxially stretched multilayer tapes 32 constituting the uniaxially stretched multilayer tape group 33 correspond to the plurality of second resin fibers of the present invention.

The uniaxially stretched multilayer tapes 30 and 32 are prepared as follows. That is, a multilayer film having the three-layer structure as shown in FIG. 4 is formed. The thus-formed multilayer film is stretched in one direction and then cut into a width of, for example, 2 mm to 7 mm along the stretching direction. Upon laminating and bonding the uniaxially stretched multilayer tape groups 31 and 33, the second thermoplastic resin layer 14 on the uniaxially stretched multilayer tape group 31 side and the second thermoplastic resin layer 14 on the uniaxially stretched multilayer tape group 33 side function as the bonding layers.

### Embodiment 6

FIG. 7 shows a fiber structure according to Embodiment 6 of the present invention. In FIG. 7, a fiber structure 106 of Embodiment 6 is prepared by weaving uniaxially stretched multilayer tapes 34 and 35. Specifically, the fiber structure 106 is formed by alternately cross-weaving the plurality of uniaxially stretched multilayer tapes 34 and the plurality of uniaxially stretched multilayer tapes 35, and then bonding them by thermal compression, for example. in this case, the uniaxially stretched multilayer tapes 34 are stretched in the axial direction (longitudinal direction) and arrayed along direction D3. The uniaxially stretched multilayer tapes 35 are stretched in the axial direction (longitudinal direction) and arrayed in direction D4 substantially orthogonal to direction D3. The uniaxially stretched multilayer tapes 34 and 35 are similar to the above uniaxially stretched multilayer tapes 30 and 32 of Embodiment 5. The fiber structure 106 (woven fabric) thus obtained by weaving the uniaxially stretched multilayer tapes 34 and 35 also has the mesh structure. In this embodiment, the plurality of uniaxially stretched multilayer tapes 34 correspond to the plurality of first resin fibers of the present invention, and the plurality of uniaxially stretched multilayer tapes 35 correspond to the plurality of second resin fibers of the present invention.

Embodiments 3 to 6 above discuss the configuration example in which both the two layers to be laminated and bonded (or two crossing tapes in weaving) contain fine particles of tungsten-based oxide. However, the present invention can also adopt the configuration in which only one of the two layers contains the fine particles of tungsten-based oxide. In this case, the plurality of resin fibers constituting the layer containing the fine particles of tungsten-based oxide correspond to the plurality of first resin fibers of the present invention, and the plurality of resin fibers constituting the layer containing no fine particles of tungsten-based oxide correspond to the plurality of second resin fibers of the present invention. The fiber structure of the present invention can, of course, have the configuration in which three or more layers are laminated and bonded. Any configuration is applicable as long as at least one layer contains fine particles of tungsten-based oxide.

### Embodiment 7

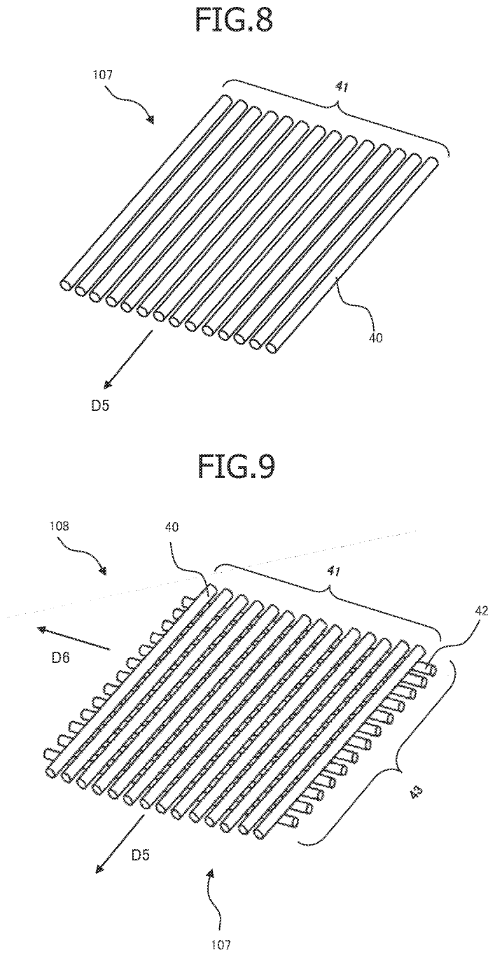

FIG. 8 is an enlarged view of a schematic structure of a fiber structure according to Embodiment 7 of the present invention, In FIG. 8, a fiber structure 107 of Embodiment 7 is formed from a long fiber array layer 41. The long fiber array layer 41 includes a plurality of long fibers 40 each containing fine particles of tungsten-based oxide in a dispersed form. The long fibers 40 are stretched in the axial direction and arrayed along one direction D5, in this embodiment, the plurality of long fibers 40 constituting the long fiber array layer 41 correspond to the plurality of first resin fibers of the present invention. Moreover, a plurality of spaces or voids that may exist between the long fibers 40 correspond to the plurality of gap portions of the present invention.

The plurality of long fibers 40 are each made of a thermoplastic resin such as polyethylene terephthalate (hereinafter referred to as “PET”), and added with a given amount of fine particles of tungsten-based oxide (heat shielding filler) as described above. The fine particles exit in a dispersed form inside the long fiber. Having high stretchability and molecular orientation as well as high spinnability, the PET is suitable as a raw material of the plurality of long fibers 40. The plurality of long fibers 40 preferably have an average fiber diameter in a range of 0.5 to 100 μm.

An example of a manufacturing method for the above fiber structure 107 is described briefly. The long fiber array layer 41 is prepared as follows. First, in a spinning step, a raw material of PET added with fine particles of tungsten-based oxide is melted and extruded from a plurality of spinning nozzles into long fibers. In this way, the plurality of long fibers extending substantially in one direction D5 are formed on a transfer conveyor. In a subsequent stretching step, the plurality of long fibers thus formed are stretched in the axial direction. Through these steps, the long fiber array layer 41 is formed, in which the plurality of long fibers 40 formed of PET containing fine particles of tungsten-based oxide in a dispersed form are stretched and arrayed along one direction D5. The thickness of the long fiber array layer 41 is determined substantially by the average fiber diameter of the long fibers 40. However, considering vertical overlap portions of the long fibers that extend substantially in one direction, the thickness is preferably in a range of 5 to 300 μm. If the thickness is too small, the long fiber array layer 41 cannot have sufficient strength, whereas if the thickness is too large, the long fiber array layer 41 becomes less flexible. In view of the above, the thickness of the long fiber array layer 41 is set in the above range.

According to the above fiber structure 107 of Embodiment 6, the long fibers 40 can be reduced in thickness to an average fiber diameter of 0.5 μm. Hence, the thin, flexible long fiber array layer 41 can be formed.

### Embodiment 8

FIG. 9 is an enlarged view of a schematic structure of a fiber structure according to Embodiment 8 of the present invention. In FIG. 9, a fiber structure 108 of Embodiment 8 is prepared as follows. That is, two long fiber array layers 41 and 43 as described in Embodiment 7 are laminated with stretching directions D5 and D6 being substantially orthogonal to each other, and then bonded by thermal compression, for example. The fiber structure 108 (nonwoven fabric including the cross-laminated long fiber array layers 41 and 43 has the mesh structure. In this embodiment, the plurality of long fibers 40 constituting one long fiber array layer, or the long fiber array layer 41, correspond to the plurality of first resin fibers of the present invention, and the plurality of long fibers 42 constituting the other long fiber array layer, or the long fiber array layer 43, correspond to the plurality of second resin fibers of the present invention.

In the above configuration, it is preferred to set different melting points (and softening points) for a thermoplastic resin serving as a base of the plurality of long fibers 40 constituting the long fiber array layer 41 and a thermoplastic resin serving as a base of the plurality of long fibers 42 constituting the long fiber array layer 43. This aims at relatively easy and stable thermal compression for integrating (bonding) the long fiber array layers 41 and 43. Specifically, regarding the thermoplastic resin serving as a base of the plurality of long fibers 40 constituting the long fiber array layer 41, PET as described in Embodiment 7 is applicable, for example, and the melting point thereof is about 260° C. Regarding the thermoplastic resin serving as a base of the plurality of long fibers 42 constituting the long fiber array layer 43, a polyethylene terephthalate copolymer (hereinafter referred to as “PET copolymer”) having the melting point of less than 240° C., preferably 210 to 230° C. is applicable, for example. The PET copolymer also has high stretchability and molecular orientation as well as high spinnability as with the above PET, and is accordingly suitable as a raw material of the plurality of long fibers 42. In this example, the PET and the PET copolymer are added with a given amount of fine particles of tungsten-based oxide (heat shielding filler) as described above. The long fibers 40 and 42 each preferably have an average fiber diameter in a range of 0.5 to 100 μm as in Embodiment 7 above.

To describe an example of a manufacturing method for the above fiber structure 108 briefly, the long fiber array layer 41 is formed similarly to Embodiment 7 above. The long fiber array layer 43 is formed as follows. First, in a spinning step, a raw material of the PET copolymer added with fine particles of tungsten-based oxide is melted and extruded from a plurality of spinning nozzles into long fibers. In addition, the extruded long fibers are exposed to the blow of high-speed air, for example, to be swung in a direction orthogonal to a conveyance direction of the transfer conveyor. In this way, the plurality of long fibers extending substantially in one direction D6 (direction orthogonal to axial direction D5 of the plurality of long fibers 40) are formed on the transfer conveyor. In a subsequent stretching step, the plurality of long fibers thus formed are stretched in axial direction D6. Through these steps, the long fiber array layer 43 is formed, in which the plurality of long fibers 42 made of the PET copolymer containing the fine particles of tungsten-based oxide in a dispersed form are stretched and arrayed in one direction D6. In a subsequent laminating step, the thus-formed long fiber array layer 41 and long fiber array layer 43 are stacked one on another on the transfer conveyor and then integrated together by thermal compression in a thermal compression step to thereby manufacture the fiber structure 108. The thickness of the fiber structure 108 is preferably in a range of 5 to 300 μm as with the thickness of the above long fiber array layer 41 of Embodiment 7.

According to the above fiber structure 108 of Embodiment 8, the two long fiber array layers 41 and 43 are laminated and bonded with stretching directions D5 and D6 being substantially orthogonal to each other. This structure can produce a thin, flexible nonwoven fabric with high strength. The above fiber structure 108 (nonwoven fabric) is suitable as, for example, a curtain, a window blind, a paper screen, clothing, or other applications.

Embodiment 8 discusses the configuration example in which both the two long fiber array layers 41 and 43 contain the fine particles of tungsten-based oxide. However, the present invention is applicable to the configuration in which only one of the long fiber array layers contains the fine particles of tungsten-based oxide. In this case, the plurality of long fibers constituting the long fiber array layer containing the fine particles of tungsten-based oxide correspond to the plurality of first resin fibers of the present invention. The plurality of long fibers constituting the long fiber array layer containing no fine particles of tungsten-based oxide correspond to the plurality of second resin fibers of the present invention. Moreover, the fiber structure of the present invention can, of course, adopt the configuration in which three or more long fiber array layers are laminated and bonded. Any configuration is applicable as long as at least one long fiber array layer contains the fine particles of tungsten-based oxide. In addition, two or more of the split web 10 (Embodiment 1), the slit web 20 (Embodiment 2), and the long fiber array layer 41 (Embodiment 6) may be freely combined, and laminated and bonded with stretching directions being substantially orthogonal to each other.

### EXAMPLES

Hereinafter, the present invention will be described in detail based on Examples. Here, in order to evaluate the performance of the fiber structure of the present invention, a plurality of evaluation samples similar to the above split web of FIG. 1 were prepared under different conditions and measured as to the transmittance of visible light and the heat shield temperature. It should be noted that Examples given below are not intended to limit the present invention.

### Example 1

As the fine particles of tungsten-based oxide, Fuji EL MWO₃ (hereinafter simply referred to as “MWO₃”) available from Fuji Pigment Co., Ltd. was used. As the polyolefin-based resin, a high density polyethylene pellet of NOVATEC (trademark) HY444 available from Mitsubishi Chemical Corporation was used. Evaluation samples were prepared under any combination of different conditions: the MWO₃ content of 0.3 wt %, 0.5 wt %, 1.2 wt %, 3.0 wt %, 4.wt %, or 6.0 wt % and the aperture ratio of the split web of 34%, 50%, or 68%. The prepared samples are given as Example 1. Here, upon preparing the evaluation samples, a 100 μm-thick sheet (single-layer film) was formed at 190° C. in a film formation step, and it was then uniaxially stretched and fiber-slit, for example.

### Example 2

As the fine particles of tungsten-based oxide, CWO (trademark) YMDS-874 (hereinafter simply referred to as “CWO”) available from Sumitomo Metal Mining Co., Ltd. was used. As the polyolefin-based resin, the above high density polyethylene pellet of HY444 was used. Evaluation samples were prepared through the same steps as Example 1 above under any combination of different conditions: the CWO content of 0.3 wt %, 0.5 wt %, 1.2 wt %, 3.0 wt %, 4.0 wt %, or 6.0 wt %, and the aperture ratio of the split web of 34%, 50%, or 68%. The prepared samples are given as Example 2.

### Comparative Example 1

As titanium oxide used in conventional nonwoven fabrics, which is an example of the heat shielding filler, a master batch (TET 1KH012WHT) available from TOYOCOLOR CO., LTD. was used. As the polyolefin-based resin, the above high density polyethylene pellet of HY444 was used. The evaluation samples were prepared through the same steps as Example 1 above under any combination of different conditions: the titanium oxide content of 1.2 wt %, 4.8 wt %, or 7.8 wt %, and the aperture ratio of the split web of 34%, 50%, or 68%. The prepared samples are given as Comparative Example 1.

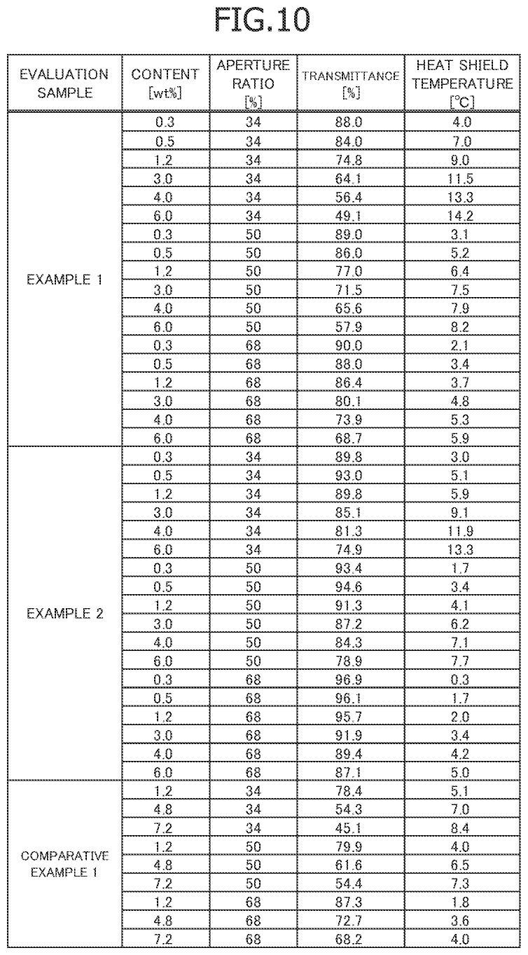

The transmittance of visible light and the heat shield temperature were measured with the use of the above plurality of evaluation samples. The transmittance of visible light is based on the total light transmittance measured by the haze meter. The heat shield temperature (=T₀−T₁[° C.]) was calculated by subtracting maximum reachable temperature T₁ obtained through any evaluation sample from maximum reachable temperature T₀ obtained through no evaluation sample, according to the above measurement method using the styrofoam box, the incandescent lamp, and the temperature sensor. FIG. 10 lists measurement results for the evaluation samples.

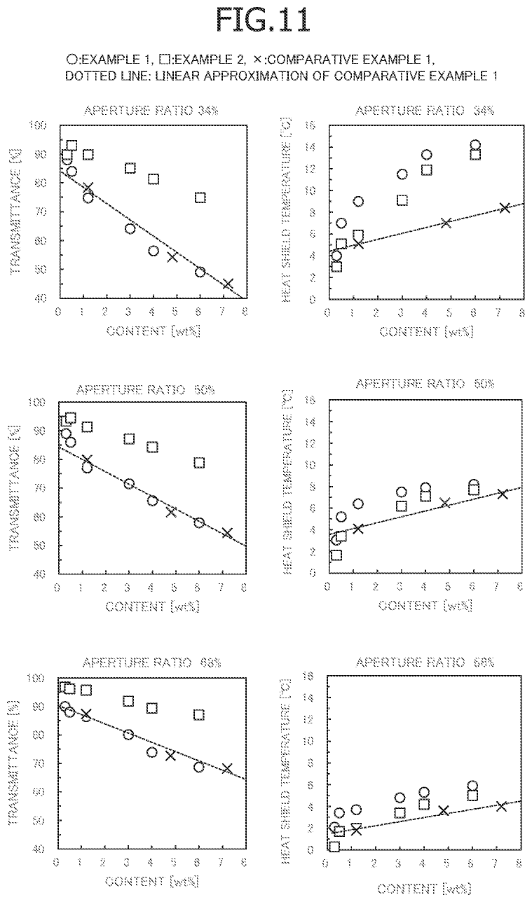

FIG. 11 shows, in graph form, a relationship of the transmittance of visible light to the content and a relationship of the heat shield temperature to the content for each measurement result of Examples 1 and 2 and Comparative Example 1. In FIG. 11, upper graphs correspond to the aperture ratio of 34%, middle graphs correspond to the aperture ratio of 50%, and lower graphs correspond to the aperture ratio of 68%. In these graphs, measurements of Example 1 are plotted and denoted by the circles, measurements of Example 2 are plotted and denoted by the squares, measurements of Comparative Example 1 are plotted and denoted by the X marks, and the broken straight line indicates linear approximation of the measurements of Comparative Example 1.

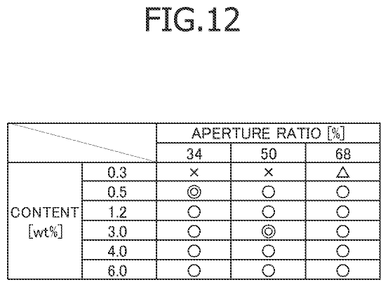

FIG. 12 is an evaluation table showing results of evaluating the advantages of Examples 1 and 2 over Comparative Example 1 based on the graphs of FIG. 11. Evaluation criteria are given below.
Excellent: Example is superior in both the transmittance and the heat shield temperature to Comparative Example 1.
Good: Example is superior in one of the transmittance and the heat shield temperature; the other is equivalent to Comparative Example 1.
Average: Example is equivalent in both the transmittance and the heat shield temperature to Comparative Example 1.
Inferior: Example is inferior in at least one of the transmittance and the heat shield temperature to Comparative Example 1.

Here, the “equivalent to Comparative Example 1” means that under the same content, the measurement of one of Examples 1 and 2 is superior to Comparative Example 1, and the other is equivalent to Comparative Example 1.

As can be understood from FIG. 12, Examples 1 and 2 had superior characteristics to Comparative Example 1 except for the result with the content of 0.3 wt %. Specifically, in view of the balance between the transmittance of visible light and the heat shielding performance, it is important to ensure that one of these two characteristics is superior to Comparative Example 1, and the other is equivalent or superior to Comparative Example 1. In this case, Examples 1 and 2 are superior with the content of 0.5 wt % to 6.0 wt %. Now, referring to FIG. 11, the lower limit of the content is described in detail. As can be seen from FIG. 11, the heat shield temperature considerably drops at between 0.3 wt % and 0.5 wt %. Thus, the content of 0.5 wt % or more improves the heat shielding performance reliably. Regarding the upper limit of the content, when the evaluation sample was prepared with a content of more than 7 wt %, it was found that the heat shielding filler aggregated in the film prior to fiber-slitting, and thus had significantly non-uniform dispersion (uneven concentration distribution), resulting in difficulties in film formation. To that end, the content is preferably set to 6 wt % or less in consideration of the evaluation results of FIG. 12 as well. As can be also seen from FIG. 11, under the same heat shielding filler content, the heat shield temperature is higher in Examples 1 and 2 than in Comparative Example 1, and the difference thereof tends to increase as the heat shielding filler content increases. This means that if the fine particles of tungsten-based oxide are used in place of titanium oxide, the fine particles can produce equal or higher heat shielding effect than a conventional one, even with a smaller content. If the content of the fine particles of tungsten-based oxide, added in order to obtain a desired heat shield temperature, can be reduced, this is effective in reducing the manufacturing cost of the fiber structure.

Moreover, the evaluation results as to the aperture ratio of FIG. 12 show that Examples 1 and 2 have superior characteristics to Comparative Example 1 throughout the range of 34% to 68% (except for the result with the content of 0.3 wt %). Now, referring to FIG. 11, an influence of the aperture ratio change is described in detail. As can be seen from FIG. 11, a larger aperture ratio leads to higher transmittance, a smaller aperture ratio leads to higher heat shield temperature, and a difference in performance (both of the heat shield temperature and the transmittance) between Examples 1 and 2, and Comparative Example 1 tends to decrease as the aperture ratio increases. As described above, if the aperture ratio excessively increases and then the gap portions between the resin fibers increase, the transmittance of visible light and the air permeability increase, but the heat shielding effect expected from the added fine particles of tungsten-based oxide is lowered. As a result, a desired heat shielding performance may not be easily available. From these perspectives, the upper limit of the aperture ratio is preferably set to 68% or less, more preferably 50% or less. In addition, the lower limit of the aperture ratio can be reduced to such a level that a substantial gap portion is formed between the plurality of resin fibers.

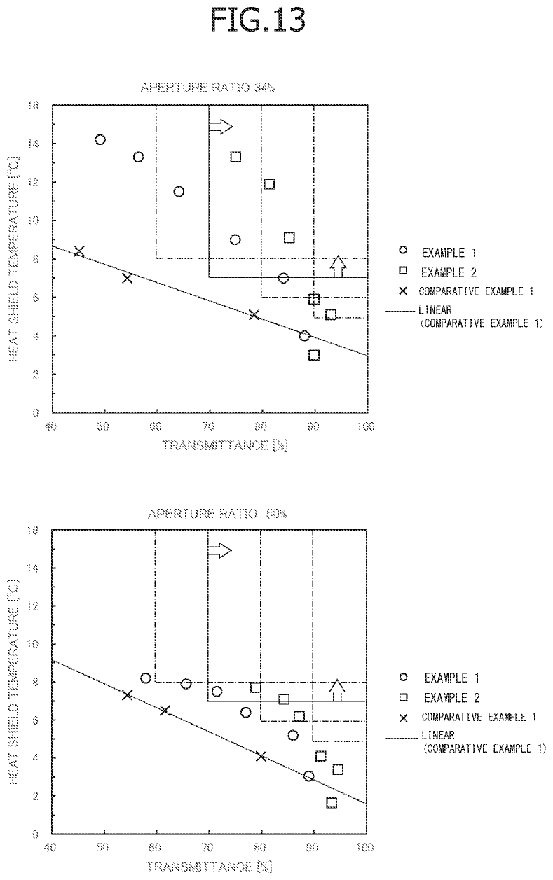

FIG. 13 shows graphs with the transmittance on the horizontal axis and the heat shield temperature on the vertical axis, in which the measurements are plotted at each content of the heat shielding filler for the evaluation samples having the aperture ratio of 34% and 50%.

As can be understood from FIG. 13, the plots (circles) of Example 1 and the plots (squares) of Example 2 are both shifted to the upper-right side of the graphs compared to the plots (X marks) of Comparative Example 1 except for the result with the content of 0.3 wt %. In other words, the balance between the transmittance of visible light and the heat shield temperature improves. This revels that if the fine particles of tungsten-based oxide are used as the heat shielding filler of the fiber structure (nonwoven fabric or woven fabric) in place of titanium oxide, high heat shielding performance can be achieved while suppressing reduction in transmittance of visible light.

As is also apparent from the above evaluation results, by setting the content of the fine particles of tungsten-based oxide and the aperture ratio of the mesh structure as appropriate, the resultant fiber structure can have higher transmittance of visible light and heat shield temperature than the conventional fiber structure using titanium oxide as the heat shielding filler. For example, in each region defined by the solid lines and outline arrows of FIG. 13, the transmittance of visible light is 70% or more, and the heat shield temperature is 7° C., or more. It can be seen that the plurality of plots of Examples 1 and 2 exist in the region. The region satisfying such conditions can be changed according to the use of the fiber structure, for example. Other than the above conditions, the following conditions can be selectively set. That is, as indicated by the dotted-dashed lines in each graph, the transmittance of visible light is 60% or more and the heat shield temperature is 8° C. or more; the transmittance of visible light is 80% or more and the heat shield temperature is 6° C. or more; and the transmittance of visible light is 90% or more and the heat shield temperature is 5° C. or more. None of these conditions are easily achievable by the conventional fiber structure using titanium oxide as the heat shielding filler. Specifically, regarding the use as the covering material for the agricultural greenhouse, for example, it is preferred, for the growth of crops, to achieve higher heat shield temperature as well as ensure the visible light transmittance of 70% or more.

### REFERENCE SYMBOL LIST

10, 15 Split web
11, 16 Base fiber
12, 17 Branch fiber
13 First thermoplastic resin layer
14 Second thermoplastic resin layer
20 Slit web
30, 32, 34, 35 Uniaxially stretched multilayer tape
31, 33 Uniaxially stretched multilayer tape group
40, 42 Long fiber
41, 43 Long fiber array layer
101 to 108 Fiber structure
D1 to D6 Stretching direction

1. A sheet-like fiber structure, comprising a plurality of first resin fibers, wherein the fiber structure has a plurality of gap portions, and the plurality of first resin fibers each contain fine particles of tungsten-based oxide in a dispersed form.

2. The fiber structure according to claim 1, wherein a content of the fine particles of tungsten-based oxide is 0.5 wt % or more and 6 wt % or less relative to a total weight of the plurality of first resin fibers.

3. The fiber structure according to claim 1, wherein the plurality of first resin fibers are stretched in a first direction.

4. The fiber structure according to claim 3, further comprising a plurality of second resin fibers which are stretched in a direction orthogonal to the first direction.

5. The fiber structure according to claim 4, wherein the plurality of second resin fibers each contain fine particles of tungsten-based oxide in a dispersed form.

6. The fiber structure according to claim 5, wherein a content of the fine particles of tungsten-based oxide is 0.5 wt % or more and 6 wt % or less relative to a total weight of the plurality of second resin fibers.

7. The fiber structure according to claim 1, wherein the fine particles of tungsten-based oxide have an average particle size of 100 nm or less.

8. The fiber structure according to claim 1, wherein the fiber structure has a mesh structure.

9. The fiber structure according to claim 8, wherein the mesh structure includes a mesh film which is stretched in one direction, or a plurality of mesh films which are stretched in one direction and laminated with stretching directions being orthogonal to each other.

10. The fiber structure according to claim 8, wherein the mesh structure has an aperture ratio of 68% or less.

11. The fiber structure according to claim 1, wherein a transmittance of visible light is 70% or more.

12. The fiber structure according to claim 11, wherein a maximum reachable temperature in a given closed space decreases by 7° C. or more when light containing infrared light is applied to the closed space through the fiber structure as compared with when the light containing infrared light is directly applied to the closed space.
